(19) United States
(12) Patent Application Publication
(10) Pub. No.: US 2024/0167808 A1
(43) Pub. Date: May 23, 2024

(54) CHROMATIC CONFOCAL MEASURING SYSTEM FOR HIGH-SPEED DISTANCE MEASUREMENT

(71) Applicant: PRECITEC OPTRONIK GMBH, Neu-Isenburg (DE)

(72) Inventors: Stephan Weiß, Rodgau (DE); Katrin Philipp, Rüsselsheim (DE); Andreas Krieger, Kelsterbach (DE); Christoph Dietz, Obertshausen (DE)

(21) Appl. No.: 18/282,759

(22) PCT Filed: Mar. 10, 2022
(86) PCT No.: PCT/EP2022/056214

§ 371 Date: Sep. 18, 2023

(30) Foreign Application Priority Data
Mar. 19, 2021 (DE) 10 2021 106 766.9

(51) Int. Cl. G01B 11/06

(52) U.S. Cl. CPC G01B 11/06; G01B 2210/50

(57) ABSTRACT

A chromatic, confocal measuring device uses a broadband, high-intensity light source implemented by optically pumping a luminophore. The illumination of the luminophore is selected so that the properties of the luminophore are exploited to maximize the optical output power of the light source.

### CROSS-REFERENCE TO RELATED APPLICATIONS

This application is a U.S. national phase application of International Application No. PCT/EP2022/056214 filed Mar. 10, 2022 and claims the benefit of and priority to earlier German patent application No. 102021106766.9 filed Mar. 19, 2021. The entire disclosures of these earlier patent applications are hereby incorporated by reference as if fully set forth herein.

### TECHNICAL FIELD

The present disclosure relates to a chromatic confocal measuring device comprising a broadband light source in the visible wavelength range up to the near infrared range.

### BACKGROUND

High-resolution optical line scanners require long-life, broadband light sources with high intensity. Phosphor converters are increasingly used as a powerful broadband source for light sources, e.g. in automotive microscopy.

The use of such broadband sources is also increasing in metrology. However, the heat generated poses a problem, leading to the favoring of dynamic solutions that result in a distribution of heat generation by moving the phosphor and thus reducing local heating. However, the mechanical movement is accompanied by a certain amount of wear and tear and thus a shorter service life. In addition, thicker phosphor layers have to be used for better mechanical stability, which leads to a reduction of the irradiation limit and thus makes part of the intensity increase gained by the motion void again. In addition, the movement and the resulting movement artifacts increase the effective emitting area, which in etendue-limited systems, as in chromatic confocal measurement methods, leads to either a lower intensity being achieved or a constant intensity having to be bought with a deteriorated resolution.

In summary, so far only a fraction of the emitted radiation is used for the measurement system. However, the unused photons also contribute to heating and thus limit the intensity and lifetime of the white light source.

### SUMMARY

It is therefore an object of the present disclosure to provide a chromatic confocal measuring device using an efficient, long-life, broadband light source that has an optimized radiation pattern for chromatic confocal sensors. High optical power of the light source is required because it limits the measurement rate of chromatic confocal single and measurement device due to the availability of fast hardware and software, and especially in the visible spectral range due to efficient detectors.

According to an aspect of the disclosure, this object is achieved by using a focused illumination of a luminophore and by using the resulting broadband measuring light in a chromatic confocal measuring device. The beam path of the imaging of the pump light source onto the luminophore and the beam path of the imaging of the luminophore onto the end of the fiber or the fiber bundle partially coincide, i.e. the light incident onto the luminophore and the light emitted by the luminophore and used as measuring light take the same path for sections, in the opposite direction. A dichroic beam splitter is used to out-couple or separate the light, which is used as measuring light and is coupled into the fiber or fiber bundle for this purpose, from the beam path to the pump source.

In an embodiment, the coincidence of the optical paths of the imaging of the pump light source onto the luminophore and of the imaging of the luminophore onto the end of the fiber or fiber bundle is implemented by the first optic and the second optic comprising at least one common imaging optical element, in particular a lens.

A chromatic confocal measuring device according to claim 1 is claimed, and a light source for use therein according to claim 14 or 15.

A chromatic confocal single-point or multi-point measuring device with a long-life and powerful broadband light source in the visible to near-infrared wavelength range for measuring distances/thicknesses of a measured object is proposed. Optical measuring devices based on the chromatic-confocal or the interferometric measuring principle are known.

A luminophore-based light source is understood to be a light source in which a pump source (typically laser or LED) is used to excite a luminescent substance (luminophore) which emits light by a physical process, in particular phosphorescence, fluorescence or scintillation. A luminophore here is generally a radiationconverting substance.

In an embodiment, pumping of the luminophore is optimized in such a way that, taking into account volume scattering and the associated change in irradiated and emitted areas, an optimal radiation pattern is generated for coupling into the measurement system.

The embodiment takes advantage of the fact that the emitting area of a luminophore is typically larger than the area irradiated by the pump light. Consequently, the optical elements in this embodiment are selected such that either the illuminated area of the luminophore is less than or equal to the lateral extent of the facet of the fiber bundle or fiber and/or the imaging of the illuminated area of the luminophore onto the fiber facet is less than its lateral dimensions.

On the one hand, this ensures that the small illuminated area of the luminophore reduces heat generation so that a long service life of the luminophore and high optical performance of the broadband light source are achieved.

At the same time, it is ensured that the lateral dimension of the emitting surface represents no or only a small limitation on the amount of light that can be coupled into the fiber or fiber bundle. To be able to couple a large angular range of the emitting light, the numerical apertures of the optics in the receiving path of the light source as well as the fiber or the individual fibers of the fiber bundle will typically be chosen to be high, with the numerical aperture of the fibers being the limiting element in most cases.

In another embodiment of the chromatic confocal measurement device, the light source is provided by appropriate selection of the first optical element or with an additional optical element in front of the dichroic mirror, the additional optical element being used to introduce spherical aberrations into the wavefront.

The following embodiments may be particularly advantageous:

The first optical element (in particular comprising a lens) is selected to produce spherical aberrations at the primary wavelength of the pump light source.

The spherical aberrations can further be created by inserting a glass platelet in front of the first optical element.

Furthermore, the spherical aberrations can be generated by an additional optical element such as a lens or a compensation plate.

The above possibilities include, in particular, arrangements in which the spherical aberrations are induced only in combination with the second optical element in the plane of the surface of the luminophore.

Furthermore, the spherical aberrations can be generated solely by the second optical element.

Additionally or alternatively, the luminophore can be shifted axially with respect to the focus of the illumination path, in particular to enlarge the spot or to optimize the beam profile by propagation invariance of optical aberrations, in particular so that the illuminated area of the luminophore has a beam profile of uniform intensity or has a beam profile rotationally symmetric intensity distribution with a dependence on the radial position, in particular an annular beam profile, an intensity profile consisting of several rings, or a flat-top profile.

In a further embodiment of the chromatic confocal measuring device, a diffractive optical element is introduced in the light source, the dichroic mirror or the beam splitter, so that the illuminated area of the luminophore has a rotationally symmetrical intensity distribution with a dependence on the radial position, in particular an annular beam profile, an intensity profile consisting of several rings or a flat-top profile.

In another embodiment of the chromatic confocal measurement device, one or more axicons in the light source are used as optical elements to generate a Bessel-Gaussian beam in the area of the luminophore.

In another embodiment of the chromatic confocal measurement device, the light source is operated with multiple pump sources that illuminate non-overlapping or partially overlapping areas on the luminophore. In the embodiment as shown in FIG. 2, the pump sources are arranged to pass through the same optical elements, with the beam paths differing in position and angle. Similarly, beam splitters can be used to merge the beam paths of the pump sources used to the extent that all beam paths pass through the second optical element. Likewise, polarization-dependent beam splitters can be used to merge the beam paths of multiple polarized pump sources with little loss of optical power.

In a similar manner, multiple non-overlapping or partially overlapping areas on the luminophore can be illuminated by using a single pump source and splitting its beam into multiple beam paths by optical elements, in particular diffractive optical elements, beam splitters or gratings.

In another embodiment, the broadband light is coupled into a fiber bundle and the sides of the fibers of the fiber bundle opposite to the coupling-in side facet of the fiber bundle are arranged at different locations of the object to be measured in a manner suitable for measuring multiple thicknesses or thicknesses. In this case, the facet on the coupling-in side is the facet of the fibers into which the light is coupled coming from the light source. On this side, the fibers may be arranged as spatially close as possible to efficiently capture the light imaged on them. The opposite side is the measuring head side.

Particularly, the fibers are arranged in a row on the measuring head side to enable measurement along a line.

In an alternative embodiment of the chromatic confocal measurement device, the luminophore of the light source is illuminated in the same manner as described previously, but the converted light is coupled into a multimode fiber instead of a fiber bundle. The light guided in the multimode fiber is split outside the light source into a line, discrete points, or other arrangement and applied to measure multiple thicknesses or thicknesses at different locations on the target. Splitting the light guided in the multimode fiber into a line can be realized, for example, by a measuring head cylindrical lens. Splitting into discrete points is achieved, for example, by using a shadow mask in the optical path downstream of the multimode fiber. It is also possible to combine, for example, a measuring head cylindrical lens with a shadow mask to obtain a line of discrete points.

An alternative embodiment provides for a chromatic confocal single-point measuring device for measuring the distance or thickness of a measured object, the light source of which is realized in the previously described manner, with the difference that a single fiber with a diameter below 300 μm, such as 50 μm, is used.

One possible embodiment of the chromatic confocal single point measuring device is characterized in that the illuminated area of the luminophore is smaller or only insignificantly larger than the fiber facet.

Another possible embodiment of the chromatic confocal measuring device includes a device according to EP 4 168 734 A1 whose entire disclosure is hereby incorporated by reference. This patent application describes an optical measuring device comprising a measuring head with imaging optics and an evaluation unit, wherein the measuring head is connected to the evaluation unit by two light-conducting fibers. The evaluation unit comprises a light source whose light is guided into the measuring head through the first light-conducting fiber, and wherein light reflected from the measuring object is guided back through the measuring head and into a second light-conducting fiber by means of a beam splitter in such a way that outgoing and return light are separated, the fiber ends being in mutually conjugated positions. The beam splitter and the fiber ends acting as apertures are arranged together in a connector which is separably connected to the measuring head.

The previously described devices can be combined with speckle reduction techniques, such as reduction of coherence amount by using a wider bandwidth pump source or by introducing frequency or phase modulation at the pump source, for example by varying the ambient temperature or diode current.

The devices described above can be extended by means of a cylindrical lens in such a way that astigmatism prevailing in the light source is corrected. In particular, if the pump light source has an asymmetrical radiation characteristic—as is the case for LEDs, for example, where the divergence angle depends strongly on the direction—this effect can be at least partially compensated for by the cylindrical lens. The cylindrical lens can be placed at different positions in the beam path between the pump light source and the luminophore, but in one embodiment between the first optical element and the dichroic beam splitter. In an embodiment, the cylindrical lens is oriented so that it acts parallel to the axis with the smaller divergence angle of the pump light source.

In an alternative embodiment, the devices described above can be designed to guide the measurement light from the light source to the measurement head using free beam optics instead of a fiber or fiber bundle.

The present disclosure also relates to a light source for use in a chromatic confocal measuring device, wherein the beam path of the imaging of the pump light source onto the luminophore and the beam path of the imaging of the luminophore onto the end of the fiber or fiber bundle partially coincide, and wherein the light source comprises a dichroic beam splitter arranged to out-couple the optical path of the imaging of the luminophore onto the end of the fiber or fiber bundle from the optical path of the imaging of the pump light source onto the luminophore.

In an alternative embodiment of the light source for use in a chromatic confocal measurement device, the pump light source is imaged onto a combination of multiple luminophores. The combination of luminophores is implemented such that two or more luminophores are stacked on top of each other or the beam path is split by a dichroic mirror or a beam splitter and illuminates a first and a second luminophore and the light emitted from the first and second luminophores is recombined by the dichroic mirror or the beam splitter.

### BRIEF DESCRIPTION OF THE DRAWINGS

Further features and advantages of the disclosure will be apparent from the following description of embodiments based on the drawings in which:

FIG. 1 shows a first advantageous embodiment of the chromatic confocal measuring device;

FIG. 2 shows a second advantageous embodiment of the chromatic confocal measuring device.

### DETAILED DESCRIPTION

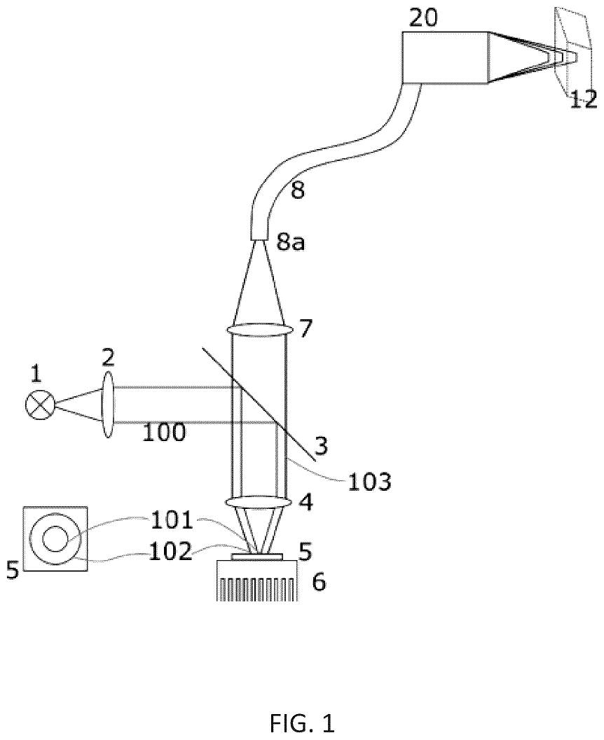

FIG. 1 shows a first advantageous embodiment of a chromatic confocal measuring device.

As an example, the chromatic confocal measuring device comprises a broadband light source in the visible wavelength range to the near infrared range.

The light source comprises a pump light source 1 in the wavelength range of 350 nm to 500 nm, which is collimated by a first optical element 2, reflected by a dichroic mirror or beam splitter 3, and focused by a second optical element 4 on or near the luminophore 5. The first optical element 2 and the second optical element 4 together form the first optics that image the pump light source 1 onto the luminophore 5.

The emitting area 102 of the luminophore may be larger than the illuminated area 101. Accordingly, broadband light is emitted from the luminophore over the total area 102.

The broadband light emitted by the luminophore 5 is in turn collimated again by the second optical element 4. The emitted light thus takes the same path of the incident light back again. After passing through the dichroic mirror or beam splitter 3 again, and being transmitted instead of reflected, and thus out-coupled, due to the dichroic nature of the beam splitter 3 and the shifted spectral distribution of the light, it is coupled into a fiber bundle or fiber 8 by a third optical element 7. The optical element 4 and the optical element 7 together form the second optics that image the luminophore 5 onto the fiber facet 8a. Thus, the entire emitting area 102 is imaged onto the fiber facet 8a. Advantageously, the extent of the imaging of the emitting area 102 onto the fiber facet 8a approximately corresponds to the extent of the fiber facet. In this way, it is ensured that both the entire fiber facet is illuminated and the light loss during coupling is minimal. Accordingly, the image of the illuminated area 101, which in one embodiment is smaller than the emitting area 102, is also smaller than the fiber facet 8a.

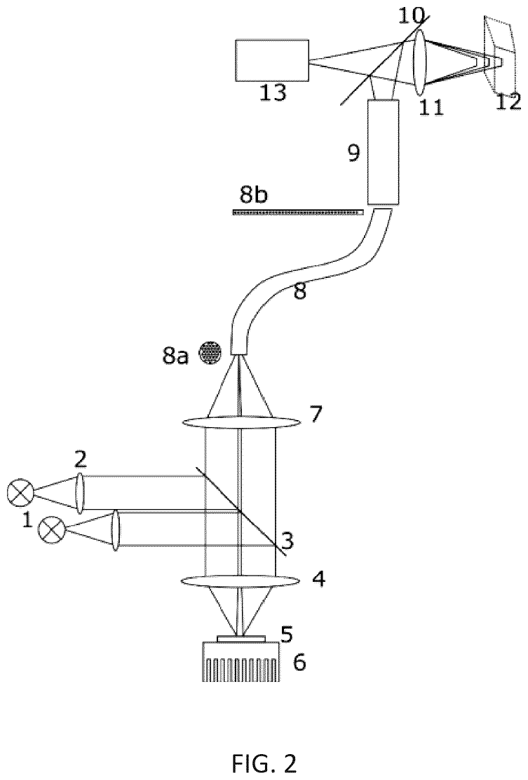

In the case where a fiber bundle 8 is used, the fiber facet 8a is all facets of the individual fibers of the fiber bundle 8 taken together. Such a facet of a fiber bundle is shown in FIG. 2.

In general, the optical elements can each comprise a lens or a group of lenses or equivalent elements (e.g. imaging mirrors).

FIG. 2 shows another embodiment of a chromatic confocal measuring device. The chromatic confocal measuring device comprises in this embodiment a broadband light source in the visible wavelength range up to the near infrared range. The light source comprises, by way of example, two pump light sources 1 which are imaged onto a luminophore 5 by means of a first and a second optical element, each comprising a first optical element 2 and a common second optical element 4 via a dichroic mirror. The luminophore is located on a heat sink 6, and the light emitted from the luminophore 5 is imaged onto the facet 8a of a fiber bundle 8 using a second optics comprising the second optical element 4 and a third optical element 7. The fibers of the fiber bundle 8 are arranged within a circular area at the first fiber end 8a, for example, and along a line at the other fiber end, for example. The light emerging from the fiber facet 8b propagates, by way of example, into a homogenizer 9, is reflected at a beamsplitting element 10, and is then focused onto the target 12 by an optical element 11, wherein the optical element 11 exhibits a dispersive behavior and generates different foci depending on the wavelength of the light.

Further embodiments of a chromatic confocal measuring device comprise combinations of individual features from FIGS. 1 and 2.

What is claimed is:

1-15. (canceled)

16. A chromatic confocal measuring device comprising:
a spectrometer;
an optical element exhibiting a dispersive behavior; and
a broadband light source configured to emit broadband light in a visible wavelength range up to a near infrared wavelength range, wherein the broadband light source includes
a fiber or fiber bundle configured to guide the broadband light towards the optical element,
a pump light source configured to emit pump light in a wavelength range from 350 nm to 500 nm,
a luminophore configured to convert the pump light into the broadband light,
first optics configured to image the pump light source onto the luminophore,
second optics configured to image the luminophore onto a facet of the fiber or fiber bundle, thereby coupling at least a portion of the broadband light into the fiber or fiber bundle, wherein a first beam path of the pump light from the pump light source to the luminophore and a second beam path of the broadband light from the luminophore onto the facet of the fiber or fiber bundle partially coincide, and
a dichroic beam splitter configured to out-couple the second beam path from the first beam path.

17. The chromatic confocal measuring device of claim 16, wherein the first optics and the second optics comprise at least one common imaging optical element.

18. The chromatic confocal measuring device of claim 16, wherein an area illuminated on the luminophore by the pump light is smaller than or equal to a lateral extent of the facet of the fiber bundle or fiber.

19. The chromatic confocal measuring device of claim 16, wherein an image of an area, which is illuminated on the luminophore by the pump light, formed on the facet of the fiber bundle or fiber is smaller than a lateral extent of the facet.

20. The chromatic confocal measuring device of claim 16, further comprising a further optical element arranged in a light path in front of the dichroic mirror and configured to introduce spherical aberrations.

21. The chromatic confocal measuring device of claim 16, further comprising a further optical element arranged in a light path behind the dichroic mirror and configured to introduce spherical aberrations.

22. The chromatic confocal measuring device of claim 16, wherein the luminophore is arranged at an axially displaced position relative to a focus of the pump light.

23. The chromatic confocal measuring device of claim 16, further comprising a plurality of pump sources configured to illuminate non-overlapping or only partially overlapping areas on the luminophore.

24. The chromatic confocal measuring device of claim 16, further comprising at least one splitting optical element that is configured to split the pump light into a plurality of pump light beam paths that illuminate non-overlapping or only partially overlapping areas on the luminophore.

25. The chromatic confocal measuring device of claim 16, wherein a fiber bundle comprises a plurality of individual fibers and guides the broadband light towards the optical element, and wherein ends of the plurality of individual fibers on a side opposite to the facet are arranged in a first pattern that is imaged by the optical element on an object to be measured for simultaneously measuring distances or thicknesses at a plurality of locations that are arranged in a second pattern that corresponds to the first pattern.

26. The chromatic confocal measuring device of claim 25, wherein the first pattern is a line.

27. The chromatic confocal measuring device of claim 16, wherein a single multi-mode fiber guides the broadband light towards the optical element, and wherein the device comprises a splitting device configured to split the broadband light, after exiting the multi-mode fiber, into a line or a plurality of discrete points for simultaneously measuring distances or thicknesses at a plurality of locations on an object to be measured.

28. The chromatic confocal measuring device of claim 16, wherein a single fiber guides the broadband light towards the optical element so that a distance of a thickness is measured on an object to be measured at a single location, and wherein the single fiber has a diameter smaller than 300 μm.

29. The chromatic confocal measuring device of claim 16, further comprising a beam splitter cube that is configured to direct the broadband light guided in the fiber or fiber bundle towards the optical element, and that is configured to direct light that has been reflected or backscattered by an object to be measured towards the spectrometer.

30. The chromatic confocal measuring device of claim 16, further comprising means for speckle reduction.

31. The chromatic confocal measuring device of claim 30, wherein the means for speckle reduction comprises a reduction of a coherence magnitude by introducing a frequency modulation or a phase modulation at the pump source.

32. The chromatic confocal measuring device of claim 31, wherein the frequency modulation or the phase modulation is achieved by varying an ambient temperature or a diode current.

33. The chromatic confocal measuring device of claim 16, further comprising a cylinder lens configured to correct an astigmatism present at the pump light source.

34. A light source for a chromatic confocal measuring device, wherein the light source is configured to emit broadband light in a visible wavelength range up to a near infrared wavelength range, the light source comprising:
a fiber or fiber bundle configured to guide the broadband light towards a measuring head of the confocal measuring device;
a pump light source configured to emit pump light in a wavelength range from 350 nm to 500 nm;
a luminophore configured to convert the pump light into the broadband light;
first optics configured to image the pump light source onto the luminophore;
second optics configured to image the luminophore onto a facet of the fiber or fiber bundle, thereby coupling at least a portion of the broadband light into the fiber or fiber bundle, wherein a first beam path of the pump light from the pump light source to the luminophore and a second beam path of the broadband light from the luminophore onto the facet of the fiber or fiber bundle partially coincide; and
a dichroic beam splitter configured to out-couple the second beam path from the first beam path.

35. A light source for a chromatic confocal measuring device, wherein the light source is configured to emit broadband light in a visible wavelength range up to a near infrared wavelength range, the light source comprising:
a fiber or fiber bundle configured to guide the broadband light towards a measuring head of the confocal measuring device;
a pump light source configured to emit pump light in a wavelength range from 350 nm to 500 nm;
a plurality of luminophores each configured to convert the pump light into the broadband light, wherein two or more luminophores are layered on top of each other;
first optics configured to image the pump light source onto the plurality of luminophores;
second optics configured to image the plurality of luminophores onto a facet of the fiber or fiber bundle, thereby coupling at least a portion of the broadband light into the fiber or fiber bundle; and
a dichroic beam splitter configured to out-couple the second beam path from the first beam path.

36. A light source for a chromatic confocal measuring device, wherein the light source is configured to emit broadband light in a visible wavelength range up to a near infrared wavelength range, the light source comprising:
a fiber or fiber bundle configured to guide the broadband light towards a measuring head of the confocal measuring device;
a pump light source configured to emit pump light in a wavelength range from 350 nm to 500 nm;
a first luminophore and a second luminophore that are both configured to convert the pump light into the broadband light;
first optics configured to image the pump light source onto the first luminophore and the second luminophore;
second optics configured to image the first luminophore and the second luminophore onto a facet of the fiber or fiber bundle, thereby coupling at least a portion of the broadband light into the fiber or fiber bundle; and
a dichroic mirror or a beam splitter arranged in a light path between the pump light source on one side and the first luminophore and the second luminophore on another side,
wherein the dichroic mirror or a beam splitter is configured to
split the pump light such that it illuminates the first luminophore and the second luminophore, and
recombine the broadband light emitted by the first luminophore and the second luminophore.
